(19) United States
(12) Patent Application Publication
(10) Pub. No.: US 2018/0088415 A1
(43) Pub. Date: Mar. 29, 2018

(54) BACKLIGHT SOURCE, BACKLIGHT MODULE, DISPLAY DEVICE AND DISPLAY SYSTEM

(71) Applicants: BOE TECHNOLOGY GROUP CO., LTD., Beijing (CN); BEIJING BOE DISPLAY TECHNOLOGY CO., LTD., Beijing (CN)

(72) Inventors: Chunbing ZHANG, Beijing (CN); Xianjuan ZHAN, Beijing (CN); Yichiang LAI, Beijing (CN)

(21) Appl. No.: 15/521,458

(22) PCT Filed: Oct. 11, 2016
(86) PCT No.: PCT/CN2016/101806

§ 371 Date: Apr. 24, 2017

(30) Foreign Application Priority Data
Jan. 20, 2016 (CN) 201610037475.7

(51) Int. Cl. G02F 1/1335

(52) U.S. Cl. CPC G02F 1/133603; G02F 1/133514

(57) ABSTRACT

A backlight source, a backlight module, a display device and a display system are provided. The backlight source includes a display light source and an interference light source; one frame time period is divided into a display time period and an interference time period; during the display time period, the display light source provides back light; and during the interference time period, the interference light source provides back light. The backlight can be applied to the display device, so that the display device possesses the anti-peeping function.

### TECHNICAL FIELD

Embodiments of the present disclosure relate to a backlight source, a backlight module, a display device, and a display system.

### BACKGROUND

At present, with the development of the display technology and network technology, more and more people do shopping, account transactions or other operations on the Internet, in the process of the above mentioned operations, an operator need to frequently input personal information in the display apparatuses such as computer, mobile phone, automatic teller machine, automatic ticket vending machine etc., so it is easy to cause unexpected disclosure of personal information. Therefore, the anti-peeping function of display apparatuses has been attracting more attention in order to ensure the personal information security of the operator. In addition, some special display apparatuses are required in some special industries, especially when confidential information need to be transmitted to a special person, the display apparatuses for transmitting the information need to possess the anti-peeping function. Therefore, how to achieve the anti-peeping function of the display apparatuses is a technical problem to be solved urgently in the related technical field.

### SUMMARY

Embodiments of the present disclosure provide a backlight source, a backlight module, a display device and a display system in order to achieve the anti-peeping function of the display apparatus.

An embodiment of the present disclosure provides a backlight source, which comprises a display light source and an interference light source. One frame time period is divided into a display time period and an interference time period; during the display time period, the display light source provides back light; and during the interference time period, the interference light source provides back light.

In one possible implementation, in the above mentioned backlight source provided in an embodiment of the present disclosure, the backlight source is a light emitting diode backlight source. In one possible implementation, the backlight source comprises a light emitting unit of first color and a light emitting unit of second color, and the first color and the second color are complementary colors. For example, the light emitting diode backlight source comprises light emitting units of six colors, including red, cyan, green, magenta, blue and yellow, wherein the light emitting units of three colors, including red, green and blue, provide the display light source, and the light emitting units of three colors, including cyan, magenta and yellow, provide the interference light source.

An embodiment of the present disclosure provides a backlight module, which comprises the above mentioned backlight source provided in an embodiment in the present disclosure, and a control module for controlling the backlight source to provide back light. The control module is configured to control the display light source in the backlight source to provide the back light during the display time period and control the interference light source in the backlight source to provide the back light during the interference time period.

An embodiment of the present disclosure provides a display device, which comprises a display panel for displaying an image, and the above mentioned backlight module provided in an embodiment of the present disclosure, wherein during the display time period, the display light source in the backlight source provides the back light for the display panel, and during the interference time period, the interference light source in the backlight source provides the back light for the display panel.

In one possible implementation mode, in the above mentioned display device provided in an embodiment of the present disclosure, the display panel comprises a plurality of first sub-pixels, a plurality of second sub-pixels and a plurality of third sub-pixels, each of the sub-pixels corresponds to light emitting units of two colors, the light emitting unit of one color provides the display light source, and the light emitting unit of another color provides the interference light source.

In one possible implementation, in the above mentioned display device provided in an embodiment of the present disclosure, on the display panel the first sub-pixel corresponds to the light emitting units of two colors, including red and cyan, the second sub-pixel corresponds to the light emitting units of two colors, including green and magenta, and the third sub-pixel corresponds to the light emitting units of two colors, including blue and yellow.

In one possible implementation, in the above mentioned display device provided in an embodiment of the present disclosure, the image displayed on the display panel is a monochrome image in one frame time period.

In one possible implementation, in the above mentioned display device provided in an embodiment of the present disclosure, the monochrome image is a white image.

In one possible implementation, in the above mentioned display device provided in an embodiment of the present disclosure, in one frame time period, a brightness of the image displayed on the display panel is the same during both the display time period and the interference time period.

An embodiment of the present disclosure provides a display system, which comprises the above mentioned display device provided in an embodiment of the present disclosure, and shutter glasses, wherein the display device displays a normal image during the display time period, the shutter glasses are in a light transmission state, and the display device displays an interference image during the interference time period, the shutter glasses are in a light shielding state.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1A and FIG. 1B are schematic diagrams of a structure of a backlight source provided in an embodiment of the present disclosure;

FIG. 2 is a schematic diagram of a structure of the light emitting unit of each color in the backlight source and the each corresponding sub-pixel in the display panel provided in an embodiment of the present disclosure; and

FIG. 3 is a schematic diagram of a structure of a display system provided in an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

An embodiment of the present disclosure provides a backlight source, which can comprise a display light source and an interference light source. One frame time period, that is, the time for displaying a frame of image, is divided into a display time period and an interference time period; during the display time period, the display light source provides back light; and during the interference time period, the interference light source provides back light.

The above mentioned backlight source provided in an embodiment of the present disclosure can be applied to an anti-peeping display apparatus, the backlight source can provide the display light source and the interference light source, in one frame time period, when the display apparatus is operating in the display time period, the backlight source provides the normal display light source, the display apparatus can display a normal image, and during the interference time period, the backlight source provides the interference light source, the display apparatus can display an interference image. Therefore, if a matched watching tool or instrument such as a pair of shutter glasses is worn to watch the display apparatus, a normal display image i.e., the image displayed in normal state can be seen; when the display apparatus is watched under the condition of taking off the shutter glasses, the whole displayed image gets close to a monochrome image because of the vision persistence phenomenon of human eyes; in this way, the display apparatus loses the effect of transmitting the display image so as to achieve the purpose of anti-peeping.

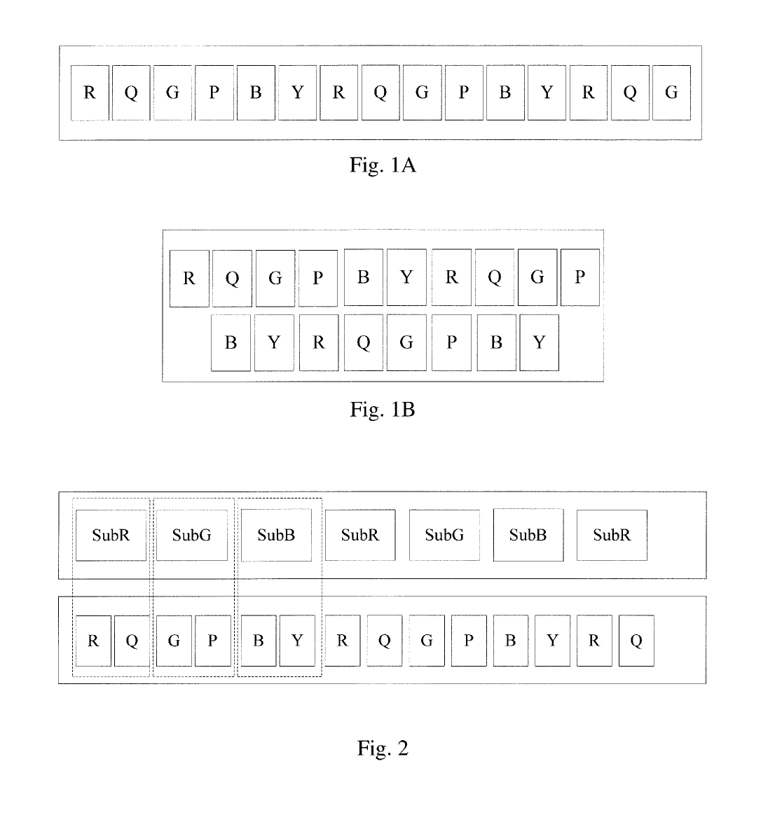

In an example, in the above mentioned backlight source provided in an embodiment of the present disclosure, as illustrated in FIG. 1A, for example, the backlight source comprises a light emitting diode, such as an inorganic light emitting diode or an organic light emitting diode backlight source, and the inorganic light emitting diode or the organic light emitting diode backlight source comprises a light emitting unit of first color (namely a light emitting unit which emits light of a first color) and a light emitting unit of second color, the first color and the second color are complementary colors to each other. For example, the inorganic light emitting diode or the organic light emitting diode backlight source comprises light emitting units of six colors, including red (R), cyan (C), green (G), magenta (M), blue (B) and yellow (Y), and the light emitting units of three colors, including red (R), green (G) and blue (B), operate as the display light source, and the light emitting units of three colors, including cyan (C), magenta (M) and yellow (Y), operate as the interference light source. But the embodiments of the present disclosure is not limited to the backlight source and the interference light source of these concrete colors, and also not limited to the linear arrangement manner as illustrated in FIG. 1A, such as a triangular (Δ) arrangement manner can be used, for example, the light emitting units of RGB form a triangle, and the light emitting units of QPY form another triangle, as illustrated in FIG. 1B.

In the above mentioned example, the above mentioned backlight source provided in an embodiment of the present disclosure can comprise light emitting units of six colors, including red (R), cyan (C), green (G), magenta (M), blue (B) and yellow (Y), so as to provide the corresponding back light during the display time period and during the interference time period; the light emitting units of three colors, including red (R), green (G) and blue (B), provide the display light source during the display time period, the light emitting units of three colors, including cyan (C), magenta (M) and yellow (Y), provide the interference light source during the interference time period, in this way in one frame time period, the normal display light source seems to be mixed with the interference light source, thereby when the display apparatus is watched under the condition of taking off the shutter glasses, the whole displayed image gets close to the monochrome image because of the vision persistence phenomenon of human eyes, the display apparatus loses the effect of transmitting the normal display image so as to achieve the purpose of anti-peeping.

Based on the same invention concept, an embodiment of the present disclosure also provides a backlight module, which comprises the above mentioned backlight source provided in an embodiment of the present disclosure, and a control module for controlling the backlight source to provide back light. The control module is configured to control the display light source in the backlight source to provide the back light during the display time period and to control the interference light source in the backlight source to provide the back light during the interference time period. For example, the backlight module provided in an embodiment of the present disclosure can provide the display light source and the interference light source respectively in one frame time period, namely the backlight module provides the normal display light source during the display time period and provides the interference light source during the interference time period, thus when the backlight module is applied to an anti-peeping display apparatus, the anti-peeping display apparatus can achieve the purpose of anti-peeping displaying.

Based on the same invention concept, an embodiment of the present disclosure further provides a display device, which can comprise a display panel for displaying an image, and the above mentioned backlight module provided in an embodiment of the present disclosure, during the display time period, the display light source in the backlight source provides the back light for the display panel, and during the interference time period, the interference light source in the backlight source provides the back light for the display panel.

In the above mentioned display device provided in an embodiment of the present disclosure, in one frame time period, when the display panel is in the display time period, the backlight source provides the normal display light source, and when the display panel is in the interference time period, the backlight source provides the interference light source. Therefore, if a user wears a matched watching tool such as shutter glasses to watch the display device, the user can see a normal display image, however, when the user takes off the shutter glasses to watch the display device, the whole displayed image gets close to a monochrome image because of the vision persistence phenomenon of human eyes. So the display device loses the effect of transmitting the display image so as to achieve the purpose of anti-peeping.

In an example, in the above mentioned display device provided in an embodiment of the present disclosure, the display panel comprises a plurality of first sub-pixels, a plurality of second sub-pixels and a plurality of third sub-pixels, each of the sub-pixels corresponds to light emitting units of two colors, the light emitting unit of one color provides the display light source and the light emitting unit of another color provides the interference light source.

The display panel generally comprises a plurality of pixel units arranged in an array, each of the pixel units comprises a plurality of sub-pixels, in the above mentioned display device provided in an embodiment of the present disclosure, the display panel can comprise a plurality of first sub-pixels, a plurality of second sub-pixels and a plurality of third sub-pixels, each of the sub-pixels of the display panel corresponds to light emitting units of two colors, the light emitting unit of one color provides the display light source for the pixel units, and the light emitting unit of another color provides the interference light source for the pixel units. In this way in one frame time period, the back light provided by the normal display light source for each of the sub-pixels on the display panel seems to be mixed with the back light provided by the interference light source, so that the whole displayed image gets close to the monochrome image, and when taking off the shutter glasses to watch the display panel, the user can not see the normal display image, and furthermore the display panel can achieve the anti-peeping displaying.

In an example, in the above mentioned display device provided in an embodiment of the present disclosure, as illustrated in FIG. 2, on the display panel the first sub-pixel (SubR) corresponds to the light emitting units of two colors, including red (R) and cyan (C), the second sub-pixel (SubG) corresponds to the light emitting units of two colors, including green (G) and magenta (M), and the third sub-pixel (SubB) corresponds to the light emitting units of two colors, including blue (B) and yellow (Y).

In the above mentioned display device provided in an embodiment of the present disclosure, the red light emitting unit and the cyan light emitting unit operate as a backlight source group for providing the back light for the first sub-pixel, thus the normal display light source is provided by the red light emitting unit, and the interference light source is provided by the cyan light emitting unit, so that in one frame time period, the red light in the back light provided for the first sub-pixel is mixed with the cyan light, the red color and the cyan color are complementary colors, so that the light of the first sub-pixel as a whole gets close to pure white, similarly the green light emitting unit and the magenta light emitting unit operate as a complementary light source group, and the blue light emitting unit and the yellow light emitting unit operate as a complementary light source group, these two groups provide the back light for the second sub-pixel and the third sub-pixel respectively, finally the displayed image of the display panel gets close to a white image so as to achieve the anti-peeping function of the display panel.

In the above mentioned display device provided in an embodiment of the present disclosure, the image displayed on the display panel is a monochrome image in one frame time period. In the above mentioned display device provided in an embodiment of the present disclosure, because the backlight source provided for the display panel comprises the display light source and the interference light source, in one frame time period, the light of the display light source is mixed with the light of the interference light source, so that each sub-pixel of the display panel emits light which gets close to monochrome light, furthermore the whole image displayed on the display panel gets close to a monochrome image, finally the display panel can achieve the anti-peeping function.

In the above mentioned display device provided in an embodiment of the present disclosure, the monochrome image displayed on the display panel can be a white image. Through setting the colors of the light emitting units of the backlight source, the image displayed on the display panel can get close to the white image, for example, red and cyan colors are complementary colors, thus mixture of red light with cyan light renders the color of the resultant light to get close to white, so the red light emitting unit and the cyan light emitting unit can be regarded as a complementary light source group for providing the back light, the light emitting units of two colors providing the back light for the same sub-pixels, which makes red light to be mixed with cyan light, then the sub-pixel can emit white light. Similarly the green light emitting unit and the magenta light emitting unit are regarded as a complementary light source group, and the blue light emitting unit and the yellow light emitting unit are regarded as a complementary light source group, finally the displayed image on the display panel gets close to a white image, so that the display panel achieves the anti-peeping function. Of course, the embodiment of the present disclosure can also adopt other colors to configure the backlight source, so that the image displayed on the display panel can be an image of another color or other image losing normal display information, such as snowflake, and herein the embodiments will not be limited in the aspect.

In the above mentioned display device provided in an embodiment of the present disclosure, in one frame time period the brightness of the image on the display panel is kept the same during both the display time period and the interference time period. During the display time period, the backlight source provides the normal display light source for the display panel, and during the interference time period, the backlight source provides the interference light source for the display panel, thus in one frame time period, each light emitting unit provides the display light source and the interference light source for each corresponding sub-pixel on the display panel, at the same time it is necessary to ensure that the brightness of the image displayed on the display panel is the same during both the display time period and the interference time period, which is conducive to obtain the complementary colors which can be mixed to get close to pure white. For example, the red light emitting unit and the cyan light emitting unit are regarded as a complementary light source group for providing the back light for the first sub-pixel, so that in one frame time period, during the display time period, the red light emitting unit provides the back light for the display panel, and during the interference time period, the cyan light emitting unit provides the back light for the display panel, the brightness of the image displayed on the display panel is kept the same in one frame time period, namely on the display image the brightness of the red light during the display time period and the brightness of the cyan light during the interference time period are the same, so that the light after mixed is pure white light rather than shifts to red light or cyan light, finally the display image on the display panel is a white image without any display information.

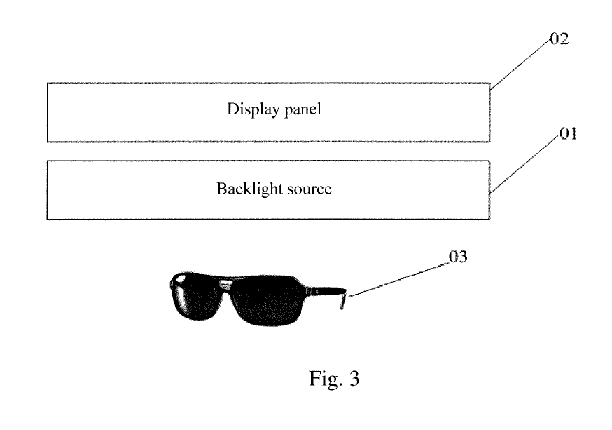

Based on the same invention concept, an embodiment of the present disclosure also provides a display system, as illustrated in FIG. 3, the display system comprises the above mentioned display device (the display device comprises a backlight 01 and a display panel 02) provided in an embodiment of the present disclosure, and shutter glasses 03; during the display time period, the display device displays a normal image, the shutter glasses 03 are in a light transmission state; and during the interference time period, the display device displays an interference image, the shutter glasses 03 are in a light shielding state.

In the above mentioned display system provided in an embodiment of the present disclosure, one frame time period is divided into the display time period and the interference time period; as illustrated in FIG. 3, during the display time period, the display light source in the backlight source 01 provides the back light for the display panel 02, the shutter glasses 03 are in the light transmission state; and during the interference time period, the interference light source in the backlight source 01 provides the back light for the display panel 02, the shutter glasses 03 are in the light shielding state. In particular, in the display system provided in an embodiment of the present disclosure, the backlight source can provide the display light source and the interference light source, so by means of the cooperation between the backlight source and the shutter glasses, in one frame time period, when the display panel is in the display time period, the backlight source provides the normal display light source, and both the right and left lenses of the shutter glasses are in the light transmission state; and when the display panel is in the interference time period, the backlight source provides the interference light source, at this time both the right and left lenses of the shutter glasses are in the light shielding state. Therefore when a user wears the shutter glasses to watch the display panel, a normal display image can be seen; when the user takes off the shutter glasses to watch the display panel, the whole display image gets close to a monochrome image because of the vision persistence phenomenon of human eyes. So the display panel loses the effect of transmitting the display image so as to achieve the purpose of anti-peeping.

In the above mentioned display system provided in an embodiment of the present disclosure, the display panel can be a liquid crystal display panel, the liquid crystal display panel comprises an array substrate configured to drive the liquid crystal display panel to display, an opposed substrate which is disposed opposite to the array substrate so as to form a liquid crystal cell, and a liquid crystal layer provided in the liquid crystal cell. Because in the above mentioned display system provided in an embodiment of the present disclosure, the backlight source is a color backlight source, therefore the array substrate or the opposed substrate may be not provided with a color filter.

In the above mentioned display system provided in another embodiment of the present disclosure, the display panel can be a liquid crystal display panel, the liquid crystal display panel comprises an array substrate configured to drive the liquid crystal display panel to display, a color filter substrate configured to filter light emitted by the backlight source, and liquid crystal provided between the array substrate and the color filter substrate; the color filter substrate is a light filter substrate without a color filter. In the above mentioned display system provided in an embodiment of the present disclosure, the display panel is a liquid crystal display panel, the liquid crystal display panel comprises an array substrate configured to drive the liquid crystal display panel to display, and a color filter substrate configured to filter light emitted by the backlight source, a liquid crystal layer is disposed between the array substrate and the color filter substrate, because in the above mentioned display system provided in an embodiment of the present disclosure, the backlight source is a color backlight source, so the color filter substrate is a light filter substrate without a color filter, and the color filter substrate can filter the light emitted by the backlight source for displaying an image on the liquid crystal display panel.

Embodiments of the present disclosure provide a backlight source, a backlight module, a display device and a display system, the backlight source comprises a display light source and an interference light source. One frame time period is divided into a display time period and an interference time period; during the display time period, the display light source provides back light; and during the interference time period, the interference light source provides back light. In particular, the backlight source provided in an embodiment of the present disclosure can be applied to an anti-peeping display apparatus, the backlight source can provide the display light source and the interference light source, in one frame time period, when the display apparatus is in the display time period, the backlight source provides the normal display light source, the display apparatus can display a normal image; during the interference time period, the backlight source provides the interference light source, the display apparatus can display an interference image. Therefore, when wearing a matched watching tool such as shutter glasses to watch the display apparatus, a user can see the normal display image, however, when the user takes off the shutter glasses to watch the display apparatus, the whole display image gets close to a monochrome image because of the vision persistence phenomenon of human eyes, so the display apparatus loses the effect of transmitting the display image so as to achieve the purpose of anti-peeping.

What are described above is related to the illustrative embodiments of the present disclosure only and not limitative to the scope of the disclosure; the scopes of the disclosure are defined by the accompanying claims.

The application claims priority to the Chinese patent application No. 201610037475.7, filed Jan. 20, 2016, the entire disclosure of which is incorporated herein by reference as part of the present application.

1. A backlight source, configured for providing back light to a display device, comprising: a display light source and an interference light source;
wherein one frame time period is divided into a display time period and an interference time period; during the display time period, the display light source provides the back light; and during the interference time period, the interference light source provide the back light.

2. The backlight source according to claim 1, wherein the backlight source is a light emitting diode backlight source.

3. The backlight source according to claim 2, wherein the backlight source comprises a light emitting unit of first color and a light emitting unit of second color, and the first color and the second color are complementary colors.

4. The backlight source according to claim 2, wherein the light emitting diode backlight source comprises light emitting units of six colors, including red, cyan, green, magenta, blue and yellow;
the light emitting units of three colors, including red, green and blue, provide the display light source; and
the light emitting units of three colors, including cyan, magenta and yellow, provide the interference light source.

5. A backlight module, comprising: the backlight source according to claim 1, and a control module for controlling the backlight source to provide a backlight;
wherein the control module is configured to control the display light source in the backlight source to provide the back light during the display time period and to control the interference light source in the backlight source to provide the back light during the interference time period.

6. A display device, comprising: a display panel for displaying an image, and the backlight module according to claim 5; wherein
during the display time period, the display light source in the backlight source provides the back light for the display panel; and
during the interference time period, the interference light source in the backlight source provides the back light for the display panel.

7. The display device according to claim 6, wherein the display panel comprises a plurality of first sub-pixels, a plurality of second sub-pixels and a plurality of third sub-pixels,
each of the sub-pixels corresponds to light emitting units of two colors, the light emitting unit of one color provides the display light source, and the light emitting unit of another color provides the interference light source.

8. The display device according to claim 7, wherein on the display panel the first sub-pixels correspond to the light emitting units of two colors, including red and cyan, the second sub-pixels correspond to the light emitting units of two colors, including green and magenta, and the third sub-pixels correspond to the light emitting units of two colors, including blue and yellow.

9. The display device according to claim 6, wherein the image displayed on the display panel is a monochrome image in the one frame time period.

10. The display device according to claim 9, wherein the monochrome image is a white image.

11. The display device according to claim 6, wherein in the one frame time period a brightness of the image on the display panel is the same during both the display time period and the interference time period.

12. A display system, comprising: the display device according to claim 1, and shutter glasses; wherein
during the display time period, the display device displays a normal image, and the shutter glasses are in a light transmission state; and
during the interference time period, the display device displays an interference image, and the shutter glasses are in a light shielding state.

13. The display device according to claim 7, wherein the image displayed on the display panel is a monochrome image in the one frame time period.

14. The display device according to claim 13, wherein the monochrome image is a white image.

15. The display device according to claim 8, wherein the image displayed on the display panel is a monochrome image in the one frame time period.

16. The display device according to claim 15, wherein the monochrome image is a white image.
